(19) United States
(12) Patent Application Publication
(10) Pub. No.: US 2026/0254897 A1
(43) Pub. Date: Aug. 27, 2026

(54) COMPUTER-IMPLEMENTED SYSTEMS AND METHODS FOR EVALUATING CONTACT CENTER PERFORMANCE USING SIMULATED AGENT EVENT AND CONTACT EVENT DATA

(71) Applicant: AFINITI AI LIMITED, Dublin (IE)

(72) Inventors: Ittai Kan, McLean, VA (US); Blake Jay Riley, Indianaplis, IN (US); Michael Richard Klugerman, Cambridge, MA (US)

(21) Appl. No.: 18/874,964

(22) PCT Filed: Jun. 15, 2023
(86) PCT No.: PCT/US23/25362

§ 371 Date: Dec. 13, 2024

Related U.S. Application Data
(60) Provisional application No. 63/352,858, filed on Jun. 16, 2022.
(60) Provisional application No. 63/471,424, filed on Jun. 6, 2023.

(51) Int. Cl. H04M 3/51; G06Q 10/0639; H04M 3/523

(52) U.S. Cl. CPC H04M 3/5175; G06Q 10/0639; H04M 3/5232; H04M 2203/401; H04M 2203/551

(57) ABSTRACT

Computer-implemented systems and methods are disclosed for simulating telecommunication contact types and analyzing contact center performance based the simulated telecommunication contact types. In various aspects, an agent start time and end time is determined for an agent of the contact center. A sequence of contact types paired to the agent between the agent start time and the agent end time is obtained as ordered in time. A simulation model implementing a simulated pairing algorithm generates a simulated sequence of contact types that is ordered in time and is different from the sequence of contact types. The simulation model pairs the simulated sequence of contact types to a simulated agent corresponding to the agent of the contact center and having a simulated agent start and end time. A performance metric of the contact center may be determined based on the simulated sequence of contact types.

### RELATED APPLICATIONS

This application claims the benefit of U.S. Provisional Application No. 63/471,424 (filed on Jun. 6, 2023) and U.S. Provisional Application No. 63/352,858 (filed on Jun. 16, 2022). The entirety of each of the foregoing provisional applications is incorporated by reference herein.

### FIELD OF THE DISCLOSURE

The present disclosure generally relates to computer-implemented systems and methods within contact centers, and more particularly, to computer-implemented systems and methods within contact centers for simulating telecommunication contact types and analyzing contact center performance based the simulated telecommunication contact types.

### BACKGROUND OF THE DISCLOSURE

A typical contact center algorithmically assigns contacts arriving at the contact center to agents available to handle those contacts. At times, the contact center may have agents available and waiting for assignment to inbound or outbound contacts (e.g., telephone calls, Internet chat sessions, email). At other times, the contact center may have contacts waiting in one or more queues for an agent to become available for assignment.

In some typical contact centers, contacts are assigned to agents ordered based on time of arrival, and agents receive contacts ordered based on the time when those agents became available. This strategy may be referred to as a “first-in, first-out”, “FIFO”, or “round-robin” strategy. In some contact centers, contacts or agents are assigned into different “skill groups” or “queues” prior to applying a FIFO assignment strategy within each such skill group or queue. These “skill queues” may also incorporate strategies for prioritizing individual contacts or agents within a baseline FIFO ordering. For example, a high-priority contact may be given a queue position ahead of other contacts who arrived at an earlier time, or a high-performing agent may be ordered ahead of other agents who have been waiting longer for their next call. Regardless of such variations in forming one or more queues of callers or one or more orderings of available agents, contact centers typically apply FIFO to the queues or other orderings. Once such a FIFO strategy has been established, assignment of contacts to agents is automatic, with the contact center assigning the first contact in the ordering to the next available agent, or assigning the first agent in the ordering to the next arriving contact. In the contact center industry, the process of contact and agent distribution among skill queues, prioritization and ordering within skill queues, and subsequent FIFO assignment of contacts to agents is typically managed by a system referred to as an “Automatic Call Distributor” (“ACD”).

Moreover, some contact centers may use a “performance based routing” or “PBR” algorithm or approach to ordering the queue of available agents or, occasionally, contacts. For example, when a contact arrives at a contact center with a plurality of available agents, the ordering of agents available for assignment to that contact would be headed by the highest-performing available agent (e.g., the available agent with the highest sales conversion rate, the highest customer satisfaction scores, the shortest average handle time, the highest performing agent for the particular contact profile, the highest customer retention rate, the lowest customer retention cost, the highest rate of first-call resolution). PBR ordering strategies attempt to maximize the expected outcome of each contact-agent interaction but do so typically without regard for utilizing agents in a contact center uniformly. Consequently, higher-performing agents may receive noticeably more contacts and feel overworked, while lower-performing agents may receive fewer contacts and idle longer, potentially reducing their opportunities for training and improvement as well as potentially reducing their compensation.

Still further, a contact center may also use behavioral pairing (BP) strategies or algorithms for assigning contacts to agents. BP algorithms target a balanced utilization of agents within queues (e.g., skill queues) while simultaneously improving overall contact center performance potentially beyond what FIFO or PBR algorithms will achieve in practice. BP improves performance by assigning agent and contact pairs in an algorithmic approach that takes into consideration the assignment of potential subsequent agent and contact pairs such that when the benefits of all assignments are aggregated, they may exceed those of FIFO and PBR strategies. In some cases, BP results in instant contact and agent pairings that may be the reverse of what a FIFO or a PBR algorithm would indicate. For example, in an instant case, a BP algorithm might select the shortest-waiting contact or the lowest-performing available agent. A BP algorithm implements posterity inasmuch as the system allocates contacts to agents in a manner that inherently forgoes what may be the highest-performing selection at the instant moment if such a decision increases the probability of better contact center performance over time.

### SUMMARY OF THE DISCLOSURE

With the various different assignment algorithms, approaches, or otherwise strategies available to contact centers, a problem arises, however, as to determination of which algorithm, approach or strategy to implement, and at what times, days, periods of time, or otherwise instances during which to implement one or more of the algorithms, approaches, or otherwise strategies for the contact center, especially for a contact center that may be specifically configured with different amounts or types of hardware (e.g., such as switches, etc.). Testing different algorithms, approaches, or otherwise strategies on actual contacts during live contact center operations can be costly to the contact center if a newly proposed algorithm, approach, or strategy performs worse than the previously-used algorithm, approach, or strategy. Further, such testing takes lengthy amounts of time in order to minimize biasing effects from data at different times of day, week, month, or noise from other confounding variables.

Accordingly, there is a need for computer-implemented systems and methods within contact centers for efficiently determining which algorithm, approach or strategy to implement, and at what times, days, periods of time, or otherwise instances during which to implement one or more of the algorithms, approaches, or otherwise strategies for the contact center The present disclosure generally relates to computer-implemented systems and methods implemented for contact centers. In particular, computer-implemented systems and methods are disclosed for simulating telecommunication contact types and analyzing contact center performance based simulated telecommunication contact types. The present disclosure relates to evaluating performance of one or more pairing strategies, such as a new discovered pairing strategies(s) or new insights for existing pairing strategies, as determined for a contact center, based on simulations that comprise simulated sequence of contact types, agent types, and pairing algorithms. For example, a pairing strategy may be based on historical contact center data, synthetic contact center data, and/or otherwise event data of a contact center, each of which, together or alone, may be used for simulations or otherwise testing. For example, in one aspect a contact center system may receive agent event data and contact event data over a period of time, where the contacts and agents were paired with a first pairing strategy. The contact center system may then use the received data to simulate, predict, or otherwise evaluate what would have happened if a second pairing strategy had been used to pair those contacts and those agents instead.

Benefits arise from simulating and/or testing various pairing strategies for a given contact center system, which may be specifically configured (with different hardware), and for certain dates or times, such as a holidays (e.g., Independence Day, Memorial Day, holiday season, or the like). For example, a contact center, and its underlying systems, operations, or other aspect of the contact center in general, may experience a performance increase from implementation from one or more of the different pairing algorithms, approaches, or otherwise strategies. Still further, and in a similar manner, a contact center may experience a performance increase for certain times of the day (e.g., early hours) from implementation from one or more of the different algorithms, approaches, or otherwise strategies for different time periods. For example, such differences in performance come from differences in the number of contacts in queue at the contact center, number of agents in queue at the contact center, or otherwise overall load on the contact center in volume of calls being handled at any given time. Other differences in performance may also include an increased number of transactions completed over a certain period of time, an increase in transactions (e.g., sales) amount, or a percentage sales increase, or the like.

In accordance with various aspects herein, a computer-implemented method is disclosed for simulating telecommunication contact types and analyzing contact center performance based the simulated telecommunication contact types. The computer-implemented method may comprise determining an agent start time for an agent of a contact center. The computer-implemented method may further comprise determining an agent end time for the agent. The computer-implemented method may further comprise obtaining a sequence of contact types paired to the agent between the agent start time and the agent end time. The sequence of contact types may be ordered in time. The computer-implemented method may further comprise generating, by a simulation model implementing a simulated pairing algorithm, a simulated sequence of contact types. The simulated sequence of contact types may be ordered in time and may be different from the sequence of contact types. The computer-implemented method may further comprise pairing, by the simulation model, the simulated sequence of contact types to a simulated agent. The simulated agent may correspond to the agent of the contact center and may have a simulated agent start time and a simulated agent end time. The simulated agent start time may be based on the agent start time, and the simulated agent end time may be based on the agent end time. The computer-implemented method may further comprise determining a performance metric of the contact center based on the simulated sequence of contact types.

In additional aspects, a system configured to simulate telecommunication contact types and to analyze contact center performance based the simulated telecommunication contact types is disclosed. The system may comprise one or more processors communicatively coupled to a contact center. The system may further comprise computing instructions, configured for execution by the one or more processors, and that when executed by the one or more processors, cause the one or more processors to determine an agent start time for an agent of the contact center. The computing instructions, when executed by the one or more processors, may further cause the processors to determine an agent end time for the agent. The computing instructions, when executed by the one or more processors, may further cause the processors to obtain a sequence of contact types paired to the agent between the agent start time and the agent end time. The sequence of contact types may be ordered in time. The computing instructions, when executed by the one or more processors, may further cause the processors to generate, by a simulation model implementing a simulated pairing algorithm, a simulated sequence of contact types. The simulated sequence of contact types may be ordered in time and may be different from the sequence of contact types. The computing instructions, when executed by the one or more processors, may further cause the processors to pair, by the simulation model, the simulated sequence of contact types to a simulated agent. The simulated agent may correspond to the agent of the contact center and may have a simulated agent start time and a simulated agent end time. The simulated agent start time may be based on the agent start time and the simulated agent end time may be based on the agent end time. The computing instructions, when executed by the one or more processors, may further cause the processors to determine a performance metric of the contact center based on the simulated sequence of contact types.

In still further aspects, a tangible, non-transitory computer-readable medium storing computing instructions for simulating telecommunication contact types and analyzing contact center performance based the simulated telecommunication contact types, is disclosed. The computing instructions when executed by one or more processors may cause the one or more processors to determine an agent start time for an agent of a contact center. The computing instructions when executed by one or more processors may further cause the one or more processors to determine an agent end time for the agent. The computing instructions when executed by one or more processors may further cause the one or more processors to obtain a sequence of contact types paired to the agent between the agent start time and the agent end time. The sequence of contact types may be ordered in time. The computing instructions when executed by one or more processors may further cause the one or more processors to generate, by a simulation model implementing a simulated pairing algorithm, a simulated sequence of contact types. The simulated sequence of contact types may be ordered in time and may be different from the sequence of contact types. The computing instructions when executed by one or more processors may further cause the one or more processors to pair, by the simulation model, the simulated sequence of contact types to a simulated agent. The simulated agent may correspond to the agent of the contact center and may have a simulated agent start time and a simulated agent end time. The simulated agent start time may be based on the agent start time, and the simulated agent end time may be based on the agent end time. The computing instructions when executed by one or more processors may further cause the one or more processors to determine a performance metric of the contact center based on the simulated sequence of contact types.

In still further aspects, the computer-implemented methods, system, and tangible, non-transitory computer-readable medium may comprise updating the contact center to operate based on the simulated pairing algorithm.

In additional aspects, a switch of the contact center may be configured to route at least a portion of one or more contacts based on the simulated pairing algorithm.

In additional aspects, the sequence of contact types may comprise a historic sequence of contact types as received at the contact center.

In additional aspects, the sequence of contact types may comprise a synthetic sequence of contact types.

In additional aspects, the sequence of contact types may comprise a modified historic sequence of contact types as received at the contact center. The modified historic sequence of contact types may comprise at least one augmented contact type as modified from a historic contact type as received at the contact center.

In additional aspects, the performance metric may comprise least one of: a telecommunication connection utilization of the contact center, a resource utilization of the contact center, a contact resolution metric associated with one or more contacts, or a transaction metric associated with one or more contacts.

In accordance with the above, and with the disclosure herein, the present disclosure includes improvements in underlying computer functionality or in improvements to other technologies at least because the present disclosure includes, e.g., determining performance metrics of a call center for improvement thereof. Such performance metrics may correspond to telecommunication connections or computing resources (e.g., memory and/or processor resources) of a call center system comprising computing systems in the field of call center routing, distribution, and/or management. That is, the present disclosure describes improvements in the functioning of an underlying computing system itself or “any other technology or technical field” because a call center, and its underlying call processing hardware and devices, are improved by allowing the call center, and related resources, such as telecommunications connections allocated in the call center system (e.g., telecommunications connections between an agent and a caller) to be routed or established based on algorithms determined from the presently-disclosed simulated sequences of contact types and/or performance metrics determined therefrom. This provides an improvement over prior systems that do not implement such simulations to determine performance metrics, as described herein. For example, such implementation improves over the prior art at least because a contact center, as improved based on insights from performance metrics as described herein, allow the systems and methods of the contact center to operate with limited or reduced resources (e.g., limited or fewer telecommunication connections and/or limited or reduced processing or memory utilization of a call processing system) or experience increased performance (e.g., transaction completion or sales) compared with non-optimizing systems. Limited or fewer telecommunication connections and/or limited or reduced processing or memory utilization of a call processing system are provided because the presently-disclosed implementation efficiently determines contact center operation through simulation instead of through consuming live resources.

Performance of a given contact center, and related metrics, may be measured or determined in terms of the resources, such as computer memory, processing, connections, whether networking or telephonic connections, of the contact center. Other performance metrics, such as number of agents (and therefore networking or telephonic connections required), may be similarly measured or determined by the simulation. For example, pairing an agent of the contact center to a contact comprises establishing a telecommunication connection to provide voice communication between the agent and the contact. Such pairing requires not only telephonic connections, but may also require processor, memory, and networking connection and/or bandwidth of the contact center and the contact. The simulation may be used to measure and determine performance metrics of such resources, in order to, for example, compare and reduce resource requirements for more efficient pairing algorithms or otherwise contact sequences, e.g., as determined for certain times, dates, or otherwise for the contact center. In addition, the simulation may also identify increase transaction (e.g., sales) performance for the contact center. In various aspects, the contact center may be updated to execute or implement pairing strategy as determined from a simulation, e.g., as determined by a simulation model as describe herein.

Additionally or alternatively, the present disclosure relates to improvements to other technologies or technical fields at least because a synthetic sequence of contact types may be manipulated or created in order to test a particular ordering or sequence of (1) contacts, (2) agents, or (3) contact-agent pairings. In such aspects, the synthetic sequence of contact types can be used to test, such as stress test or load balance, a contact center system. In addition, such manipulated or created event data may be used to test one or more performance metrics of a contact center system. In this way, the synthetic sequence of contact types can be used improve the performance of one or more features of the contact center system, by determination of the performance metrics, for example, by determining which pairing sequence provides an improvement in terms of reduced telecommunication connection usage, reduced memory usage, reduced processing usage, reduced handle time, and/or increased performance of transactions and/or sales, or other benefits to the contact center as described herein.

In addition, the present disclosure includes the application of or use of a particular machine, e.g., one or more switches or routers as deployed in a contact center, call center, or otherwise associated with a service provider, where a switch or router may be configured to operate according to a pairing algorithm as determined by simulation in accordance with the systems and methods for determining, evaluating, and/or otherwise optimizing or improving performance metrics of a contact center as described herein.

Still further, the present disclosure includes specific features other than what is well-understood, routine, conventional activity in the field, because such features add unconventional steps that confine the disclosure to a particular useful application, e.g., computer-implemented systems and methods within contact centers for simulating telecommunication contact types and analyzing contact center performance based the simulated telecommunication contact types.

Advantages will become more apparent to those of ordinary skill in the art from the following description of the preferred aspects which have been shown and described by way of illustration. As will be realized, the present aspects may be capable of other and different aspects, and their details are capable of modification in various respects. Accordingly, the drawings and description are to be regarded as illustrative in nature and not as restrictive.

The present disclosure will now be described in more detail with reference to particular aspects thereof as shown in the accompanying drawings. While the present disclosure is described below with reference to particular aspects, it should be understood that the present disclosure is not limited thereto. Those of ordinary skill in the art having access to the teachings herein will recognize additional implementations, modifications, and aspects, as well as other fields of use, which are within the scope of the present disclosure as described herein, and with respect to which the present disclosure may be of significant utility.

### BRIEF DESCRIPTION OF THE DRAWINGS

To facilitate a fuller understanding of the present disclosure, reference is now made to the accompanying drawings, in which like elements are referenced with like numerals. These drawings should not be construed as limiting the present disclosure, but are intended to be illustrative only.

FIG. 1 depicts a block diagram of a contact center system, in accordance with various aspects of the present disclosure.

FIG. 2A depicts a block diagram of a contact center system with an external pairing system, in accordance with various aspects of the present disclosure.

FIG. 2B depicts a block diagram of a contact center system with a remote computing device, in accordance with various aspects of the present disclosure.

FIG. 3 illustrates a schematic representation of an example queue of a contact center, in accordance with aspects of the present disclosure.

FIG. 4 illustrates a computer-implemented method for simulating telecommunication contact types and analyzing contact center performance based the simulated telecommunication contact types, in accordance with various aspects of the present disclosure.

FIG. 5 illustrates a flow chart demonstrating algorithm execution of an initial sequence compared with a simulated sequence, in accordance with various aspects of the present disclosure.

FIG. 6 illustrates a computer-implemented method for simulating telecommunication contact-agent pairings and analyzing contact center performance based the simulated telecommunication contact-agent pairings, in accordance with various aspects of the present disclosure.

### DETAILED DESCRIPTION

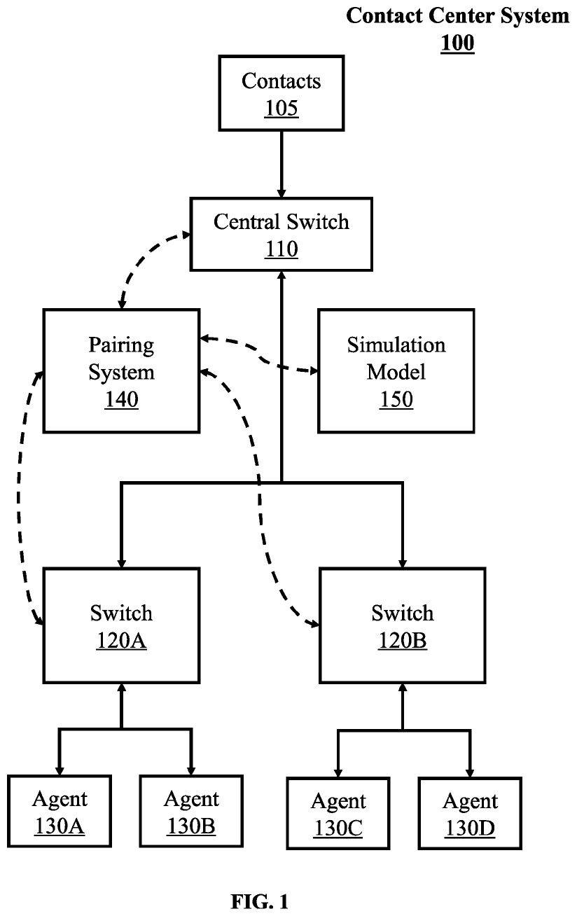

FIG. 1 depicts a block diagram of a contact center system 100, in accordance with various aspects of the present disclosure. As illustrated by the contact center system 100 of FIG. 1, the systems and methods herein comprise network elements, computers, and/or computing instructions for simulating contact center systems that may include one or more modules. As used herein, the term “module” may be understood to refer to computing software, instructions, firmware, hardware, and/or various combinations thereof. Modules, however, are not to be interpreted as software which is not implemented on hardware, firmware, or recorded on a processor readable recordable storage medium (i.e., modules are not software per se). It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

As shown in FIG. 1, the contact center system may include a central switch 110. The central switch 110 may receive incoming contacts 105 (e.g., callers) or support outbound connections to contacts via a dialer, a telecommunications network, or other modules (not shown). The central switch 110 may include contact routing hardware and software for helping to route contacts among one or more contact center systems, or to one or more Private Branch Exchanges (PBXs) and/or Automated Call Distribution (ACD) systems or other queuing or switching components within a contact center. The PBX and/or ACD may manage, route, or otherwise distribute calls based on one or more distribution rules, such as the number called, line, timetable, and other parameters, which are configurable to dynamically update or change the operation of the contact center. The rules of the PBX and/or ACD, or more generally the operation of the PBX and/or ACD, may be modified, updated, or otherwise configured by pairing system 140 and/or the simulation model 150.

In some aspects, the central switch 110 may not be necessary if there is only one contact center, or if there is only one PBX/ACD routing component, in the contact center system 100. If more than one contact center is part of the contact center system 100, each contact center may include at least one contact center switch (e.g., contact center switches 120A and 120B). The contact center switches 120A and 120B may be communicatively coupled to the central switch 110.

Each contact center switch for each contact center may be communicatively coupled to a plurality (or “pool”) of agents. Each contact center switch may support a certain number of agents (or “seats”) to be logged in at one time. At any given time, a logged-in agent may be available and waiting to be connected to a contact, or the logged-in agent may be unavailable for any of a number of reasons, such as being connected to another contact, performing certain post-call functions such as logging information about the call, or taking a break.

In the example of FIG. 1, the central switch 110 routes contacts to one of two contact centers via contact center switch 120A and contact center switch 120B, respectively. Each of the contact center switches 120A and 120B are shown with two agents each. Agents 130A and 130B may be logged into contact center switch 120A, and agents 130C and 130D may be logged into contact center switch 120B. It is to be understood, however, that additional or fewer agents may be allocated or otherwise associated with a given switch or router within a contact center system.

In various aspects, the contact center system 100 may also be communicatively coupled to a pairing system 140. Pairing system 140 may comprise a computing system including one or more processors, one or more memories, and related computing instructions for execution of software or instructions as described herein. In some aspects, pairing system 140 may be integrated as part of the contact center system 100, such as integrated into an existing computing device, switch, or router of the contact center. That is, in some aspects, pairing system 140, may be embedded within a component of a contact center system (e.g., embedded in or otherwise integrated with a switch). Additionally, or alternatively, pairing system 140 may be a separate computing system (e.g., such as a computing device as provided by a third party) that is connected via a computer network of the contact center. That is, in some aspects, switches of the contact center system 100 may be communicatively coupled to pairing system 140 via a network or otherwise cable connection, and, in some aspects, may include multiple pairing systems like pairing system 140. In the example of FIG. 1, pairing system 140 is communicatively coupled to one or more switches in the switch system of the contact center system 100, including central switch 110, contact center switch 120A, and contact center switch 120B.

Pairing system 140 may receive information (i.e., contact center data, such as event data of the contact center, or other information of the contact center) from a PBX/ACD of the contact center system 100 and/or a switch (e.g., contact center switch 120A) of the contact center system 100 about agents logged in to the switch or otherwise into the contact center system 100 (e.g., agents 130A and 130B) and about incoming contacts. In some aspects, such information may be received via another switch (e.g., central switch 110) or, in some aspects, from a network (e.g., the Internet or a telecommunications network) (not shown). As the term is used herein, contact center event data refers to electronic information defining events of the contact center. Contact center event data comprises contact data and agent data. For example, contact event data may refer to event data regarding contacts, such as a contact arriving or otherwise connecting at a contact center, a contact leaving or otherwise disconnecting from the contact center, or a contact's interactions with the contact center, which may include the contact's pairing by the pairing system, interactions with an agent, selections made (e.g., such as menu selections from a number phone menu or other selection interface causing the contact to be routed or directed in one or more ways within the call routing network or other network of the contact center system), decisions made by the contact during the contact's interaction with an agent of the contact center system, or any other event that defines interaction or status of the contact with the contact center. Similarly, as a further example, agent event data may refer to event data regarding agents, such as an agent logging into or otherwise connecting at a contact center, an agent logging out or otherwise disconnecting from the contact center, or an agent's interactions with the contact center, which may include the agent's pairing by the pairing system, interactions with a contact, selections made (e.g., such as menu selections from a menu while the agent handles or otherwise interacts with a contact), decisions made by the agent during a contact-agent pairing, or any other event that defines interaction or status of the agent with the contact center.

The pairing system 140 may process this information to determine which contacts should be paired (e.g., matched, assigned, distributed, or otherwise routed within contact center system 100) with which agents. That is, pairing system 140, or more generally contact center system 100, is configured to algorithmically assign contacts arriving at the contact center to agents available to handle those contacts. At times, the contact center may be in an “L1 state” as defined by a state where contact center 100 has agents available and waiting for assignment to inbound or outbound contacts (e.g., telephone calls, Internet chat sessions, email). At other times, the contact center may be in an “L2 state” (i.e., an L2 queue) as defined by a state where contact center 100 has contacts waiting in one or more queues for an agent to become available for assignment. Such L2 queues could be inbound, outbound, or virtual queues.

Contact center system 100 may be configured to implement various strategies for assigning contacts to agents in both L1 and L2 states. Pairing system 140 is configured to select, modify, and/or switch between or among the various strategies or otherwise pairing algorithms based on one or more parameters or states of the contact center system 100. For example, in one aspect, multiple agents may be available and waiting for connection to a contact (i.e., contact center system 100 is in an L1 state), and a contact arrives at the contact center via a network or central switch. If the contact center system 100 and/or pairing system 140 is implementing a FIFO strategy or otherwise algorithm, the contact center system 100 may automatically distribute the new contact to whichever available agent has been waiting the longest amount of time for an agent. As a further example, if a contact center system 100 or pairing system 140 is implementing a PBR strategy, the contact center system 100 may automatically distribute the new contact to whichever available agent has been determined to be the highest-performing agent. Still further, if a contact center system 100 or pairing system 140 is implementing a BP strategy, the contact center system 100 may optimally assign contacts to agents using specific information about either tasks or agents, or both. Various BP strategies may be used, such as a diagonal model BP strategy or a network flow BP strategy. These task assignment strategies and others are described in detail for the contact center context in, e.g., U.S. Pat. Nos. 9,300,802 and 9,930,180, which are hereby incorporated by reference herein..

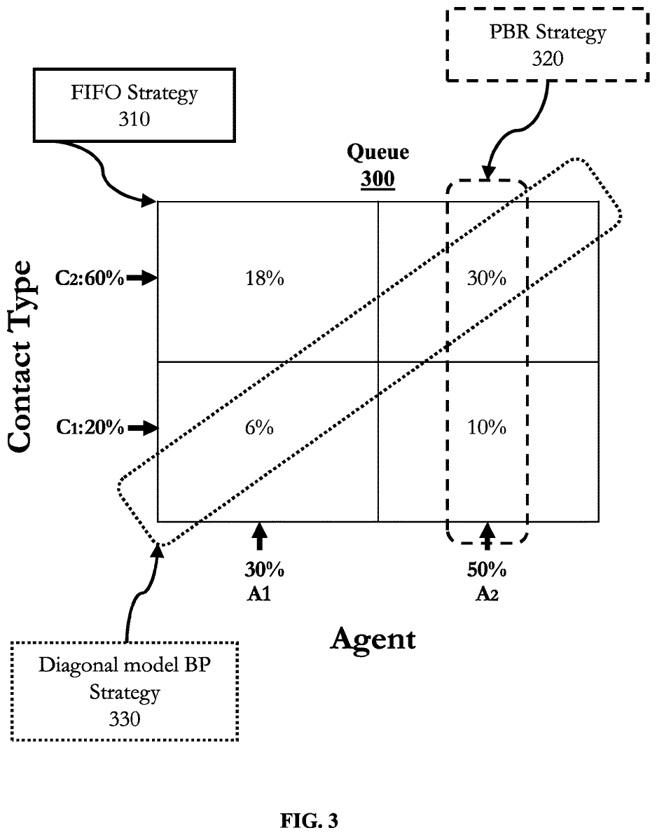

When contact center system 100 is in an L2 state, multiple contacts are available and waiting for connection to an agent. These contacts may be queued in a contact center switch such as a PBX or ACD device (“PBX/ACD”). If the contact center system 100 and/or pairing system 140 is implementing a FIFO strategy or otherwise algorithm, the contact center system 100, pairing system 140, and/or contact center switch will typically connect a newly available agent to whichever contact has been waiting on hold in the queue for the longest amount of time. If multiple agents become available for an L2 state, and the contact center system 100 and/or pairing system 140 is implementing a PBR strategy or otherwise algorithm, the contact center system 100 and/or pairing system 140, will pair the new contact with the highest performing agent. Still further, for an L2 state, and where the contact center system 100 and/or pairing system 140 is implementing a BP strategy or otherwise algorithm, the contact center system 100 and/or pairing system 140, the contact center system 100 may optimally assign agents to contacts using specific information about either tasks or agents, or both. Various BP strategies may be used, such as a diagonal model BP strategy or a network flow BP strategy. In addition, in some contact centers, priority queuing may also be incorporated. The various pairing strategies or otherwise algorithms are further described with respect to the contact center queue of FIG. 3.

A simulation model 150 may be linked to pairing system 140, and may receive and transmit event data, information, and pairing algorithms for testing and controlling operation of the contact center system 100, which may be based on simulated pairing algorithms and sequences, for example, as described herein. Simulation model 150 may comprise computing instructions stored in memory and configured to execute one or more processors within, or communicatively coupled to, contact center system 100 and pairing system 140. In various aspects, simulation model 150 may be implemented by a separate computing device (e.g., a server) communicatively connected (e.g., via a network or cable connection) to pairing system 140. Alternatively, simulation model 150, may be integrated with (e.g., stored in memory with or as part of a set of computing instructions or application with) pairing system 140.

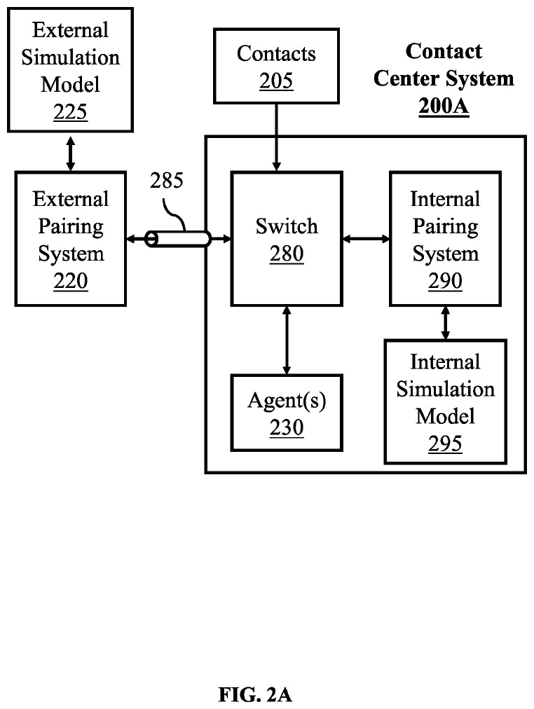

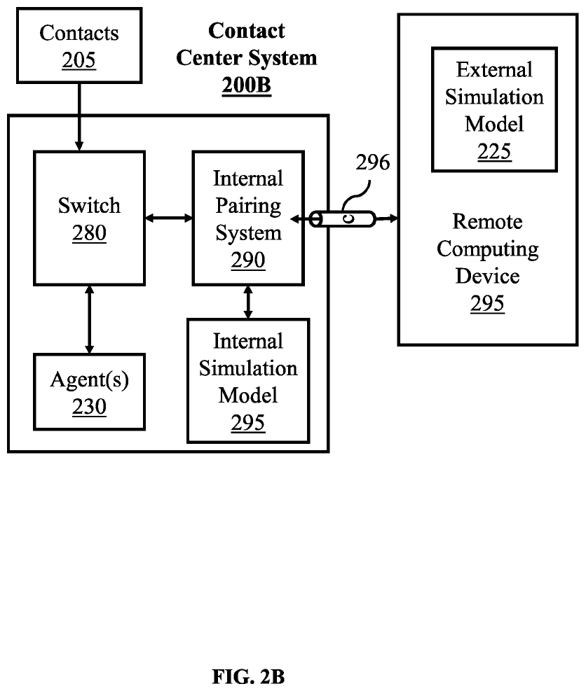

In some aspects, simulation model 150 may comprise computing instructions that pair or otherwise execute or implement a pairing algorithm. For example, in various aspects, simulation model 150 may be configured to implement a pairing strategy as would be executed for the same configuration (e.g., having the same equipment or hardware, e.g., central switch 110, etc.) of the contact center system 110. Simulation may occur with simulated event data and, at least initially, may not affect pairing of actual (live) contacts and agents within the contact center system. That is, simulations may be performed separate from, or offline to, the actual or live operation of the contact center. Additionally, or alternatively, such simulations may be performed externally to (e.g., via external simulation model 225 as described for FIG. 2A and/or FIG. 2B) or internally at (via internal simulation model 295 as described for FIG. 2A and/or FIG. 2B) a contact center system (e.g., contact center system 100 and/or contact center system 200) as described herein.

Additionally, or alternatively, simulation model 150 may comprise a machine learning model. For example, simulation model 150 may include a machine learning model, or algorithm for training a machine learning model, that is configured to input contact center data, such as contact information, agent information, or event data defining sequences or timing therefor, and/or one or more pairing strategies or algorithms of the contact center system (e.g., contact center system 100) in order predict, classify, or determine performance metrics of the contact center as described herein. Performance metrics may include any one or more of telecommunication connection utilization of the contact center, a resource utilization of the contact center, a contact resolution metric associated with one or more contacts, or a transaction metric associated with one or more contacts, or other performance metric as described herein. The simulation model 150 may be trained to determine improvements to any one of these performance metrics based on different sequences of contacts, agents, and/or pairing strategy currently utilized by the contact center system (e.g., contact center system 100). In various aspects, a machine learning model of simulation model 150 may be trained using a supervised or unsupervised machine learning program or algorithm. The machine learning program or algorithm may employ a neural network, which may be a deep learning neural network. In some aspects, the artificial intelligence and/or machine learning based algorithms, as used to train simulation model 150, may be included as a library.

Machine learning as applied to simulation model 150 may involve identifying and recognizing patterns in existing data, such as contact center data or related event data (e.g., arrival time(s) of contact(s) or availability of agent(s)), in order to facilitate making predictions or identification for subsequent data (such as determining performance metrics of the contact center system). For example, a machine learning model, such as the machine learning model of simulation model 150 as described herein, may be created and trained based upon training data (e.g., data or information regarding contacts, agents, arrival times, log in or log out times, handle times, sales or transaction information, telecommunication connection status or utilization, memory or processor resource utilization of the contact center system, or other information or data described herein) as inputs or data (which may be termed “features” and “labels”) in order to make valid and reliable predictions for new inputs, such as testing level or production level data or inputs (e.g., for determining performance metrics of the contact center). In supervised machine learning, a machine learning program operating on a server, computing device, or otherwise processors, may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on a server, computing device, or otherwise processors as described herein, to predict or classify, based on the discovered rules, relationships, or model, an expected output, score, or value.

In unsupervised machine learning, the server, computing device, or otherwise processors, may be required to find its own structure in unlabeled example inputs, where, for example multiple training iterations are executed by the server, computing device, or otherwise processors to train multiple generations of models until a satisfactory model, e.g., a model that provides a compressed representation of data or inputs, or otherwise a classification, when given test level or production level data or inputs, is generated.

Supervised learning and/or unsupervised machine learning may also comprise retraining, relearning, or otherwise updating models with new, or different, information, which may include information received, ingested, generated, or otherwise used over time. The disclosures herein may use one or both of such supervised or unsupervised machine learning techniques.

It is to be understood that simulation model 150 may be used to determine simulated sequences and related performance metrics, using artificial intelligence (e.g., a machine learning model of simulation model 150) or, in alternative aspects, without using artificial intelligence. More generally, simulations (whether using artificial intelligence or not) may be performed to test, measure, or otherwise determine pairing strategies for the contact center (e.g. contact center system 100) to determine performance metrics of the contact center as described herein. The simulations performed by simulation model may be used to update or configure the pairing system 140 to operate according to a new or different pairing algorithm that was determined based on a simulated pairing algorithm as tested, determined, or measured by simulation model 150. In such instances, the new or different pairing algorithm may be uploaded, transmitted, or otherwise provided to pairing system 140 (e.g., via a computer network or via a computer bus), where the pairing system 140 may cause the contact center system (e.g., via configuration of one or more switches, the PBX, or ACD, etc.) to begin to execute or implement the new or different pairing algorithm.

FIG. 2A depicts a block diagram of a contact center system 200A with an external pairing system 220, in accordance with various aspects of the present disclosure. Contact center system 200A represents an additional, or alternative, configuration of a contact center system compared to contact center system 100. It is to be understood, however, that the disclosure provided herein for contact center system 100 with respect to routing and pairing contacts applies to contact center system 200A. In contact center system 200A, a contact center system 200A may route contacts 205 to a plurality of agents 230. The contact center system 200A may include routing hardware and software, such as switch 280 and/or one or more PBX or ACD routing components or other queuing or switching components for helping to route the plurality of contacts 205 among the plurality of agents 230.

In the contact center system 200A, an internal pairing system 290 may be communicatively coupled to the contact center system 200A. The internal pairing system 290 may be native to (or built in) the contact center system 200A (i.e., “first-party”) or may be provided by a third-party vendor. Typically, the internal pairing system 290 may implement traditional pairing strategies (e.g., FIFO or PBR) or some other pairing strategy that may be proprietary to the contact center system 200A. However, the internal pairing system 290 may also comprise the pairing system 140 as described for FIG. 1. The internal pairing system 290 may receive or otherwise retrieve information from the contact center system 200A about the agents 230 logged into the contact center system 200A and about the incoming contacts 205.

In the contact center system 200A, external pairing system 220 may be communicatively coupled to the contact center system 200A via an interface 285. Interface 285 may isolate the contact center system 200A from the external pairing system 220 (e.g., for security purposes), and control or otherwise allow information exchanged between the two systems. An example of the interface 285 may be a public or a private proprietary application programming interface (API), such as a Representational State Transfer (RESTful) API, provided over a network (e.g., the Internet or a telecommunications network) (not shown).

With further reference to FIG. 2A, simulation models may be configured to be external or internal to the contact center system 200A, and may be further configured to generate simulation sequences of contact types, determine one or more performance metrics of the contact center based on the simulated sequence of contacts, update the operation of the contact center based on one or more simulations, or perform other such operations as provided by simulation models as described herein. For example, internal simulation model 295 is communicatively coupled to internal pairing system 290. In some aspects, internal simulation model 295 may be a separate application, computer program, or otherwise set of computing instructions from the internal pairing system 290. In such aspects, internal simulation model 295 may interact with or communicate with the internal pairing system 290 via an API or otherwise through data exchange. Additionally, or alternatively, internal simulation model 295 may be integrated with, or be part of, internal pairing system 290.

More generally, internal simulation model 295 comprises computing instructions, program code, one or more data structures (e.g., a neural network) that is integrated with, or is accessible to, internal pairing system 290. In various aspects, internal pairing system 290 may comprise computing instructions that interact with, or access, via input and output, internal simulation model 295. For example, internal pairing system 290 may provide data (e.g., contact and agent data) to internal simulation model 295 and may receive output (e.g., predictions, performance metrics, simulation pairing algorithms) for updating operation of contact center 200A to operate in accordance with pairing algorithms determined from simulation by the internal simulation model 295.

External simulation model 225 may be communicatively coupled to external pairing system 220. In some aspects, external simulation model 225 may be a separate application, computer program, or otherwise set of computing instructions from the external pairing system 220. In such aspects, external simulation model 225 may interact with or communicate with the external pairing system 220 via an API or otherwise through data exchange. Additionally, or alternatively, external simulation model 225 may be integrated with, or be part of, external pairing system 220. Still further, external simulation model 225 may be communicatively coupled to the contact center system 200A through external pairing system 220 via interface 285. Additionally, or alternatively, external simulation model 225 may directly connected (not shown) to contact center system, for example, through interface 285. External simulation model 225 may communicate with contact center system 200A via interface 285 to update operation (e.g., based on a simulated pairing algorithm) or otherwise allow information exchanged between the external simulation model 225 and the contact center system 200A. An example of the interface 285 may be a public or a private proprietary application programming interface (API), such as a Representational State Transfer (RESTful) API, provided over a network (e.g., the Internet or a telecommunications network) (not shown). The API may be the same or a different (API) as used by the external pairing system 220 for communicating with contact center system 200A. External simulation model 225 comprises computing instructions, program code, one or more data structures (e.g., a neural network) that may be integrated with, or is accessible to, external pairing system 220. In various aspects, external pairing system 220 may comprise computing instructions that interact with, or access, via input and output, external simulation model 225. For example, external pairing system 220 may provide data (e.g., contact and agent data, or related event data) to external simulation model 225 and may receive output (e.g., predictions, performance metrics, simulation pairing algorithms) for updating operation of contact center 200A to operate in accordance with pairing algorithms determined from simulation by the external simulation model 225.

In some aspects, relative to the internal pairing system 290, the external pairing system 220 may have access to less information associated with contact center system 200A, e.g., a limited subset of information that is selected and shared by the contact center system 200A. Similarly, relative to the internal pairing system 290, the external pairing system 220 may have less control over the operation of contact center system 200A. Such information and/or control is nonetheless generally sufficient for the external pairing system 220 to determine the contact-agent pairing and convey the determined contact-agent pairing to contact center system 200A. External pairing system 220 may be provided by a third-party vendor and may be in the form of the pairing system 140 described above. The external pairing system 220 may provide a pairing strategy (e.g., BP strategy) that improves the performance of the contact center system 200A when compared to one or more pairing strategies typically provided by the internal pairing system 290. In some aspects, the external pairing system 220 may also provide the same or a similar one or more pairing strategies as that of the internal pairing system 290.

In some aspects, the contact center system 200A may operate under a shared control, in which the contact center system 200A may send route requests to either or both of the internal pairing system 290 and the external pairing system 220 to determine which contact is to be routed to which agent. The shared control may be desirable, for example, when the internal pairing system 290 employs a traditional or proprietary pairing strategy (e.g., FIFO or PBR) that may not be provided by the external pairing system 220, while the external pairing system 220 is used to provide a higher-performing pairing strategy (e.g., a BP pairing strategy or algorithm). In this way, each of the external pairing system 220 and/or internal pairing system 290 may use less resources, such as less memory and/or processing, because external pairing system 220 and internal pairing system 290 may offload or otherwise separate pairing computations or determining of a given pairing across a networked environment.

When the external pairing system 220 includes the same or a similar pairing strategy as that of the internal pairing system 290, the contact center system 200A may operate under full control such that the contact center system 200A sends all route requests to the external pairing system 220. In other words, the external pairing system 220 has full control on determining every contact-agent pairing. Under the full control, at times, the external pairing system 220 may simulate/mimic the pairing strategy of the internal pairing system 290 (e.g., FIFO or PBR) and, at other times, may employ a different pairing strategy (e.g., BP), and send its pairing recommendation to the contact center system 200A over the interface 285. The contact center system 200A may then assign the contacts 205 to agents 230 based on the pairing recommendation.

In other examples as shown in FIG. 2B, the external simulation model 225 may be part of a remote computing device 295 in contact center 200B. The remote computing device 295 may be connected to the contact center via an interface 296, and control or otherwise allow information exchanged between the internal pairing system 290 and the remote computing device 295. An example of the interface 285 may be a public or a private proprietary application programming interface (API), such as a Representational State Transfer (RESTful) API, provided over a network (e.g., the Internet or a telecommunications network) (not shown). Otherwise, contact center 200B may be similar to contact center 200A. Otherwise the components of contact center 200B may be as provided regarding the components of contact center 200A.

In some aspects, the performance of the external pairing system 220 may be determined at least in part by a number of pairing choices available to the external pairing system 220 at a given point in time. For example, in an L1 environment (agent surplus, one contact; select among multiple available/idle agents), the number of pairing choices corresponds to the number of agents that are available. In an L2 environment (contact surplus, one available/idle agent; select among multiple contacts in queue), the number of pairing choices corresponds to the number of contacts available. In an L3 environment (multiple agents and multiple contacts; select among pairing permutations), the number of pairing choices corresponds to the number of permutations between the number of agents and contacts that are available.

The effect of having a small number of pairing choices may be to reduce the performance gains that can be derived from using a higher performing pairing strategy (e.g., BP strategy) relative to a traditional pairing strategy (e.g., FIFO or PBR). For example, when one agent and one contact are available, there is a single pairing choice, so any pairing strategy will select the same pairing. On the other hand, when many agents and/or contacts are available, this yields a large number of pairing choices. The strategy for selecting among this large number of pairing choices can have a significant impact on performance. Accordingly, the difference between a high performing pairing strategy and a traditional pairing strategy generally increases with the number of pairing choices. The relationship between the number of available pairing choices and performance is described in detail in, e.g., U.S. Pat. No. 10,257,354, which is incorporated by reference herein.

Consequently, to improve the performance of a high performing pairing strategy, it may be desirable to delay or otherwise postpone the selection of a pairing between an agent and a contact when the number of pairing choices is too small to achieve the desired level of performance (e.g., when the number of pairing choices is below a predetermined threshold, or when the contact center system 200A and/or 200B is in the L1 or L2 state). Postponing the selection may provide time for new contacts to be added to the queue or more agents to become available, thereby increasing the number of pairing choices. In some embodiments, delaying the selection may allow the contact center system 200A and/or 200B to transition from an L1 or L2 state (where the number of pairing choices increases linearly with the number of contacts or agents) to an L3 state (where number of pairing choices increases super-linearly with the number of contacts or agents).

When a pairing strategy is implemented by internal pairing system 290, postponing the selection can be implemented by directly monitoring the state of a contact center system (e.g., contact center system 100 and/or contact center system 200A and/or 200B) and waiting until the number of pairing choices exceeds a threshold. See, e.g., U.S. Pat. No. 10,257,354. However, for pairing strategies implemented by the external pairing system 220, adding a period of delay may involve an exchange of communications over an API between external pairing system 220 and contact center system 200, in order to coordinate or share control between external pairing system 220 and internal pairing system 290.

FIG. 3 illustrates a schematic representation of an example queue 300 of a contact center system (e.g., contact center system 100, contact center system 200A or contact center system 200B), in accordance with aspects of the present disclosure. Queue 300 is an electronic or in-memory queue (e.g., a computer memory queue) that stores information regarding contacts and agents for the contact center system (e.g., contact center system 100 or contact center system 200). Queue 300 may be implemented in a computing device, such as a switch of contact center system 100, contact center 200A and/or contact center system 200B, or other device as described herein. FIG. 3 is provided herein to demonstrate various different pairing algorithms that may be implemented for a contact center system and how the different pairing algorithms have an impact on operation of the contact center system based on different permutations of arrival times of the contacts, types of contacts, availability of agents, types of agents, and other information or data of the contact center system. The various pairing algorithms are examples only of types of pairing algorithms that may be used for sequences, simulated sequences, or otherwise simulations as described herein.

Queue 300 illustrates an example queue that addresses a simplified hypothetical case in which two types of contacts are available be assigned to either of two available agents in an environment in which the contact center is seeking to maximize performance of the contact center system (e.g., contact center system 100, contact center system 200A, and/or contact center system 200B). In the example of FIG. 3, two evenly distributed contact types are a “60% Contact” (C₂) and “20% Contact” (C₁), with the former contact (C₂) more likely to make a purchase, enter a transaction, have decreased handle time, have a faster call resolution time, or other increased performance metric relative to the latter contact (C₁). The two agents are a “50% Agent” (A₂) and a “30% Agent” (A₁), with the former agent (A₂) more likely to make a sale, start a transaction, have decreased handle time, have a faster call resolution time, or other increase performance metric relative to the latter agent (A₁). This example further presumes that the four possible interactions between contacts and agents have some expected outcome associated with the interaction such that when a 60% Contact (C₂) is assigned to the 50% Agent (C₂), the overall probability of positive performance metric (e.g., increased sales output, decreased handle time, or other performance metric described herein) may be 30%. This can be gathered by historical contact-agent interaction data of when a contact of a similar type to C₂ was paired with A1. Similarly, historical contact-agent interaction data can be used to determined expected outcomes for the other possible pairings. Accordingly, the four expected outcomes in this example are 6%, 10%, 18%, and 30%. Contacts C₁ and C₂ may correspond to contacts 105 and/or 205 of contact center system 100 and contact center system 200. Similarly, Agents A₁ and A₂ may correspond to Agents 130A, 130B, 130C, 130D and/or 230 of contact center system 100 and/or contact center system 200, respectively.

When the contact center system is implementing a FIFO algorithm (e.g., FIFO Strategy 310), all four possible outcomes are equally likely. For example, if a 60% Contact (C₂) arrives with both the 30% Agent (A₁) and the 50% Agent (A₂) available, either agent might be selected with equal probability based on, for example, which agent has been waiting longer or has been utilized less. Similarly, if the 30% Agent (A₁) comes available with both a 60% Contact (C₂) and a 20% Contact (C₁) in Queue 300, either contact may be selected with equal probability and equal priority based on, for example, which contact has been waiting longer (e.g., earlier time of arrival). Therefore, in FIFO Strategy 310, the overall expected performance metric (e.g., expected sales output, handle time, or other performance metric described herein) of Queue 300 would be (6%+10%+18%+30%)/4=16%.

When the contact center system is implementing a PBR algorithm (e.g., PBR Strategy 320), the 50% Agent (A₂) is preferentially assigned contacts whenever the 50% Agent (A₂) is available. Therefore, PBR Strategy 320 would achieve its highest overall expected performance output (e.g., expected sales output, handle time, or other performance metric described herein) in the case where the 50% Agent (A₂) is always available upon arrival of a contact. This peak expectation is (10%+30%)/2=20%. However, this peak expectation is unlikely to be achieved in practice. For example, contacts may arrive while the 50% Agent (A₂) is engaged and the 30% Agent (A₁) is available. In this instance, PBR Strategy 320 would assign the contact to the 30% Agent (A₁). Thus, PBR performance in practice will approximate the performance of FIFO Strategy 310 in proportion to the percentage of instances in which non-preferred assignments occur. In many cases, multiple contacts may be waiting in Queue 300 (L2 state), and there may not be an opportunity to preferentially select the 50% Agent (A₂). If Queue 300 were persistently in an L2 state, PBR Strategy 320 would be expected to perform at the same rate as FIFO Strategy 310. In fact, if half the time queue 300 was in an L2 state, and a further quarter of the time 50% Agent (A₂) was unavailable because 50% Agent (A₂) had been preferentially selected, then PBR Strategy 320 would still offer no expected improvement over FIFO Strategy 310. In Queue 300, PBR Strategy 320 only offers significant performance benefit over FIFO Strategy 310 when Queue 300 is in an L1 state for an extended period and, within that L1 state, there exists choice between the 50% Agent(A₂) and the 30% Agent (A₁). However, in this case Queue 300 may be “overstaffed” inasmuch as it would require significant idle labor (and thus idle telecommunication connections and related resources, such as memory and processor resources) for potentially minor benefit. Accordingly, in practice PBR may be ineffective at substantially improving performance over FIFO.

When the contact center system is implementing a diagonal model BP algorithm (e.g., diagonal BP Strategy 330), a 20% Contact (C₁) is preferentially assigned to the 30% Agent (A₁), and a 60% Contact (C₂) is preferentially assigned to the 50% Agent (A₂). Therefore, the peak expectation of Queue 300 performance under diagonal BP Strategy 330 is (6%+30%)/2=18%. Importantly, this peak expectation does not erode like PBR Strategy 320 in an L2 state.

Hypothetically, if there was an arbitrarily long queue of contacts in a persistent L2 state, diagonal BP Strategy 330 would in fact operate at peak expected performance because whenever the 30% Agent (A₁) became available there would be a 60% Contact (C₂) pending assignment, and whenever the 50% Agent (A₂) became available there would be a 20% Contact (C₁) pending assignment.

Even though there are only two agents maximally available in the example of Queue 300, BP Strategy 330 may still outperform PBR Strategy 320 in an L1 state. For example, if the 50% Agent (A₂) was occupied half of the time, PBR Strategy 320 would deliver no benefit as the other half of the time PBR Strategy 320 would be forced to select the 30% Agent (A₁). However, in an L 1 state under diagonal BP Strategy 330, availability of a 20% Contact (A₁) would trigger use of the lower-performing 30% Agent (A₁) in the instant pairing, thereby preserving the higher-performing 50% Agent (A₂) for subsequent assignment. Thereafter, in the next iteration, if a 60% Contact (C₂) became available for assignment then the assignment of the preserved 50% Agent (A₂) would result in delivering diagonal BP Strategy 330's expected peak overall performance of 18%. This should occur approximately half the time, resulting in a significant improvement over both FIFO and PBR assignment strategies. When a pairing is to be made, the available agents may be ordered, and the available contacts may be ordered.

In FIG. 3, for the diagonal BP strategy 330, the 50% Agent (A₂) was selected for preferential pairing with 60% Contacts (C₂), and the 30% Agent (A₁) was selected for preferential pairing with 20% Contacts (C₁). It is to be understood that FIG. 3 provides only an example aspect of a diagonal BP strategy, and that that additional or difference strategies, including different types or implementations of BP strategies may be executed. For example, various BP strategies or otherwise algorithms may be used.

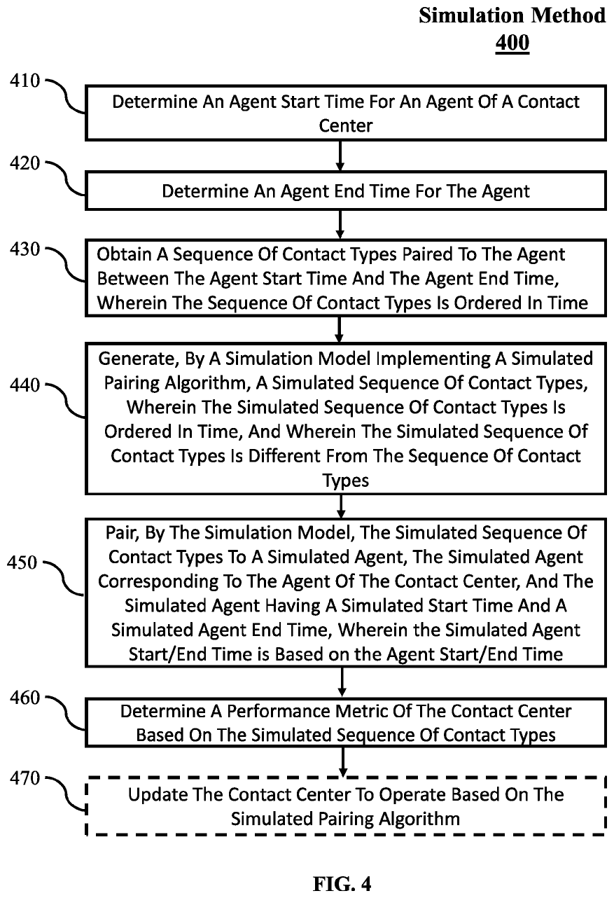

FIG. 4 illustrates a computer-implemented method 400 for simulating telecommunication contact events, agent events, and contact-agent pairing events, and analyzing contact center performance based the simulated telecommunication contact events, agent events, and contact-agent pairing events, in accordance with various aspects of the present disclosure. Computer-implemented method 400 comprises an algorithm or computing instructions as may be implemented in a contact center, or contact center system (e.g., contact center system 100, contact center system 200A, and/or contact center system 200B), and may involve the processing of input data and the generation of output data, both of which may comprise call center related data, including data regarding agents, contacts, (or events thereof, including arrival of contacts and/or availability of agents) and/or determination of performance metrics as described herein. Input data and output data receipt, transmission, and/or generation may be implemented in hardware or software components of contact center system. For example, specific electronic components may be employed in a pairing algorithm, as implemented on one or more processors and/or memories of a contact center system, or similar or related circuitry for implementing the functions associated with simulations and/or pairing in a contact center system (e.g., contact center system 100, contact center system 200A, and/or contact center system 200B). Additionally, one or more processors operating in accordance with computing instructions may implement the functions associated with pairing and/or simulation in a contact center system (e.g., contact center system 100, contact center system 200A, and/or contact center system 200B) as described herein, including for method 400. Such instructions may be stored on one or more non-transitory processor readable storage media (e.g., a magnetic disk or other storage medium), or transmitted to one or more processors via one or more signals embodied in one or more carrier waves, for example, across one or more computer buses and/or computer networks. In various aspects, the one or more processors that implement the algorithm of method 400, or otherwise execute the computing instructions as described herein, may comprise one or more processors of a computing device of the contact center system itself, such as one or more processors of a computing device, server, router, or the like that is communicatively coupled to the contact center system.

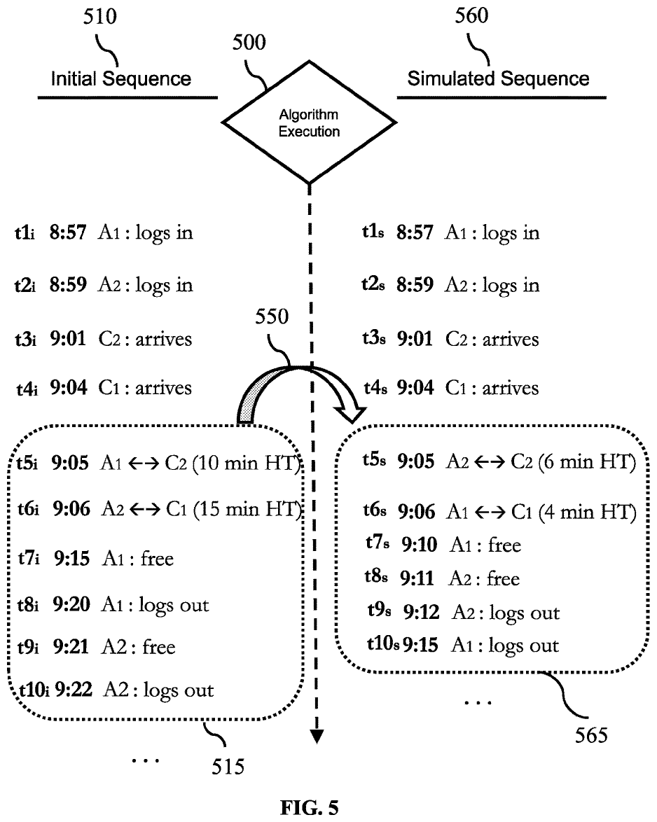

With reference to FIG. 4, at block 410 computer-implemented method 400 comprises determining an agent start time for an agent (e.g., agent A₂ as described for FIG. 3 or FIG. 5) of a contact center. For example, the agent start time corresponds to a time that the agent is logged into a contact center and/or is otherwise available to receive contact pairing assignments to the agent from a switch.

At block 420 computer-implemented method 400 further comprises determining an agent end time for the agent (e.g., agent A₂). For example, the agent end time corresponds to a time that the agent logs out of the contact center and/or is otherwise is unavailable to receive further contact pairing assignments to the agent from the switch.

At block 430 computer-implemented method 400 further comprises obtaining a sequence of contact types paired to the agent between the agent start time and the agent end time. For example, the sequence of contact types corresponds to contacts (e.g., contacts C₁ and C₂ of FIG. 3 or FIG. 5) arriving, or otherwise connecting to, the contact center system. The sequence of contact types may be ordered in time.

In some aspects, the sequence of contact types may comprise a historic sequence of contact types as received at the contact center. Such historic sequence may comprise actual times that the contacts types connected to the contact center system and were available for connection to an available agent by the switch of the contact center.

Alternatively, in additional aspects, the sequence of contact types may comprise a synthetic sequence of contact types. In some examples, such synthetic sequence of contact types may be randomly generated, or otherwise not corresponding to historic (or actual) times at which contacts connected to a contact center system (e.g., contact center system 100 and/or contact center system 200). In some examples, such synthetic sequence of contact types may be manipulated or created in order to test a particular ordering of contacts. In such aspects, the synthetic sequence of contact types can be specifically determined or configured to arrive (or connect) at specific times.

More generally, the synthetic sequence of contact types may be used to test, such as stress test or load balance, a contact center system. In addition, such manipulated or created data, such as event data, may be used to test one or more performance metrics of a contact center system (e.g., contact center system 100 and/or contact center system 200) or a contact center pairing strategy, as described herein. In this way, the synthetic sequence of contact types can be used improve the performance of one or more features of the contact center system.

In some examples, the synthetic sequence of contact types may comprise a-historic or otherwise experimental contact types that are synthetically generated.

In some examples of block 430, the computer-implemented method 400 further comprises obtaining historic contact center event data corresponding to the obtained sequence of contact types. For example, the obtained historic contact center event data further comprises agent data for a plurality of agents logged into the contact center between the agent start time obtained at block 410 and the agent end time obtained at block 420.

At block 440 computer-implemented method 400 further comprises generating, by a simulation model (e.g., simulation model 150), a simulated sequence of contact types. The simulated sequence of contact types may be ordered in time and is different from the sequence of contact types obtained at block 430. FIG. 5, as described further herein, shows an example sequence of contact types and an example simulated sequence of contact types, which are differently configured.

The simulated sequence of contact types comprises at least one modified event as modified from the sequence of contact types obtained at block 430. That is, a contact event, an agent event, and/or any contact center event may be modified. For example, a time that a contact arrived may be modified. Additionally, or alternatively, a type of the contact (e.g., a percentile value of a contact, or a percentile for which the contact is within for a given performance metric) may be modified from the original (actual) value as historically received at the contact center system. Additionally, or alternatively, an agent pairing of the contact (may be modified from the original (actual) agent pair as historically made at the contact center system.

Further, the simulated sequence of contact types may comprise a plurality of events that are different from the obtained sequence of contact types and/or any historic contact center event data corresponding to the obtained sequence of contact types. For example, a contact disconnection rate may be applied to the obtained sequence of contact types, selections made by the contact or agent may be modified (e.g., such as menu selections from a number phone menu or other selection interface causing the contact to be routed or directed in one or more ways within the call routing network or other network of the contact center system), or any other event that defines interaction or status of the contact with the contact center may be modified in the simulated sequence of contact types as compared to the obtained sequence of contact types.

At block 450 computer-implemented method 400 further comprises pairing, by the simulation model, the simulated sequence of contact types to a first simulated agent. The first simulated agent may correspond to the agent (e.g., A₂) of the contact center and may have a simulated agent start time and a simulated agent end time. The simulated agent start time may be based on the agent start time, and the simulated agent end time may be based on the agent end time. In this way, a specific sequence or sequence portion, corresponding to a simulated sequence of contact types, may be generated or determined for use in simulation.

That is, either at least one contact receives a different agent in the simulated sequence than in the obtained sequence or at least one agent receives a different contact in the simulated sequence than in the obtained sequence.

For example, the pairing of the simulated sequence of contact types may comprise postponing a pairing of a contact to a simulated agent so that the contact center is likely to move from an L1 state or an L2 state into an L3 state.

For example, the pairing of the simulated sequence of contact types may comprise contact types of the simulated sequence of contact types being paired to one or more simulated agents other than the first simulated agent. For example, the one or more simulated agents may correspond to a plurality of logged-in agents between the agent start time and the agent end time.

For example, the pairing of the simulated sequence of contact types may be based on a different pairing strategy than a pairing strategy used to pair the historic obtained sequence of contact types of block 430. For example, the historic obtained sequence of contact types may use PBR strategy 320 or FIFO strategy 310, while the pairing of the simulated sequence of contact types according to block 430 uses diagonal BP strategy 330 or a network flow BP strategy. In some examples, the historic obtained sequence of contact types may use the diagonal BP strategy 330, while the pairing of the simulated sequence of contact types according to block 430 uses a network flow BP strategy. In some examples, the historic obtained sequence of contact types uses a diagonal BP strategy 330 where the agents and/or contacts are percentiled in a first order, while the pairing of the simulated sequence of contact types according to block 430 uses a diagonal BP strategy 330 where the agents and/or contacts are percentiled in a second order, different from the first order. Altogether the present disclosure contemplates any difference in pairing strategy between the pairing of the historic obtained sequence of contact types and the pairing of the simulated sequence of contact types.

At block 460 computer-implemented method 400 further comprises determining a performance metric of the contact center based on the simulated sequence of contact types. In various aspects, the performance metric may comprise one or more of a telecommunication connection utilization of the contact center, a resource utilization of the contact center, a contact resolution metric associated with one or more contacts, and/or a transaction metric (e.g., a transaction completion indication and/or a sales or revenue data) associated with a given simulated sequence for the contact center. Additionally, or alternatively, performance of the contact center, and related metrics, may also be measured in terms of the resources, such as computer memory, processing, connections, whether networking or telephonic connections, of the contact center. Other performance metrics, such as number of agents (and therefore networking or telephonic connections required), may be similarly measured or determined by the simulation. For example, pairing an agent of the contact center to a contact comprises establishing a telecommunication connection to provide voice communication between the agent and the contact. Such pairing requires not only telephonic connections, but may also require processor, memory, and networking connection and/or bandwidth of the contact center. The simulation may be used to measure and determine performance metrics of such resources, in order to, for example, compare and reduce resource requirements for more efficient pairing algorithms or otherwise contact sequences, e.g., as determined for certain times, dates, or otherwise for the contact center.

In some examples, the performance metric may be compared to a performance metric corresponding to the obtained sequence of contact types from block 430.

At block 470 computer-implemented method 400 may further comprise updating the contact center to operate based on the simulated pairing algorithm. For example, in some aspects, a switch (e.g., any one of central switch 110, switch 120A, switch 120B, and/or switch 280, as described herein), the PBX, and/or the ACD of the contact center may be configured to route at least a portion of one or more contacts based on the simulated pairing algorithm. By updating, or otherwise configuring, the contact center to use the simulated pairing algorithm, the contact center (and at least a portion of its underlying computing technology, e.g., connections and usage thereof) may be improved by a new, efficient pairing algorithm as determined by the simulation.

Therefore, simulation method 400 improves over the prior art at least because the disclosed simulation method tests new or modified pairing strategies without requiring actual telecommunication connections between live agents and live contacts. Such offline testing reduces processing and/or memory utilization of a contact processing system during contact center hours of operation. Additionally, simulation method 400 evaluates new or modified pairing strategies by comparing performance metrics of the new or modified pairing strategies to historical contact center pairing strategies; this evaluation is much quicker than the hours, days, months, or years that testing the new or modified pairing strategies on live agents and live contacts would take. Further, when showing contact center performance data to an entity not associated with the contact center system, simulated data can be used to preserve information security of the actual (or historic) data.

FIG. 5 illustrates a flow chart demonstrating algorithm execution 500 of an initial sequence 510 compared with a simulated sequence 560, in accordance with various aspects of the present disclosure. Each of the initial sequence 510 and simulated sequence 560 may comprise event data that includes a respective sequence of contact types (e.g., corresponding to contacts 105 and/or contacts 205) for pairing with respective agents (e.g., agents 130A, 130B, 130C, 130D, and 230) of a contact center system (e.g., such as contact center system 100 and/or contact center system 200). The event data may be used to execute or perform simulations for determining performance metrics of the contact center system, as further described below, and as otherwise described herein.

As shown in the example of FIG. 5, initial sequence 510 may be an initial sequence of a contact center system (e.g., such as contact center system 100 and/or contact center system 200). As illustrated, initial sequence 510 are ordered in time from time t1ᵢ (at 8:57) to t9ᵢ (at 9:22), which may represent times the morning (AM) or evening (PM). It is to be understood that initial sequence 510 may be representative of only a portion of a sequence for which the contact center system may receive contacts, analyzes agent information, or otherwise determines or generates a sequence of related contact center information for contacts and agents in the contact center system.

Further, initial sequence 510 illustrates example contact types, e.g., contact type C₁ and contact type C₂. Each of C₁ and C₂ may be the same as described for FIGS. 3 and 4 and may represent a contact of a given type, where the type may be analyzed based on the algorithm currently implemented by the contact center system. For example, such as when the contact center system is implementing a BP algorithm, then C₁ may have a contact type determined to be in a first order percentile. Similarly, when the contact center system is implementing the BP algorithm, then C₂ may have a contact type determined to be in a second order percentile. In some examples, such as when the contact center system implements a FIFO or PBR algorithm, C₁ and C₂ may have contact types determined to be low priority and high priority contacts, respectively. More generally, contacts C₁ and C₂ may be contacts arriving at contact center system 100 or contact center system 200, such as contacts 105 or contacts 205, respectively. It is to be understood that additional contact types may also be part of initial sequence 510, where such additional contact types may comprise, for example, any of C₁, C₂, C₃, C₄, C₅, etc. where each contact type is classified, ordered, determined, or otherwise based on the corresponding pairing algorithm currently implemented by the contact center system.

Initial sequence 510 also illustrates two agents A₁ and A₂. Agents A₁ and A₂ represent agents of a given type based on the algorithm currently implemented by the contact center system. For example, when the contact center system is implementing a BP algorithm, then A₁ may have an agent type determined to be in a first order percentile and A₂ may have an agent type determined to be in a second order percentile. Alternatively, when the contact center system implements a FIFO or PBR algorithm, At may have an agent type determined to be a first ordered agent and A₂ may have an agent type determined to be a second ordered agent, where the agents are ordered in time or otherwise ordered according to the given algorithm's pairing strategy or otherwise execution. More generally, Agents A₁ and A₂ may represent agents for pairing to contact (e.g., C₁ and C₂) of having respective contact types and may correspond to any of the agents as described herein, for example, any of agents 130A, 130B, 130C 130D of FIG. 1 and/or Agent(s) 230 of FIG. 2A and/or FIG. 2B, or otherwise as described herein. It is to be understood that additional agent types may also be part of initial sequence 510, where such additional agent types may comprise, for example, any of A₁, A₂, A₃, A₄, A₅, etc. where each agent type is classified, ordered, determined, or otherwise based on the corresponding pairing algorithm currently implemented by the contact center system.

In some aspects, initial sequence 510 may comprise a historic sequence of contact types as was received (e.g., in the past) at the contact center. Alternatively, or additionally, the initial sequence 510 may comprise a modified historic sequence of contact types as received at the contact center. Additionally, or alternatively, initial sequence 510 may comprise a synthetic sequence of contact types. The synthetic sequence of contact types may comprise a-historic or otherwise experimental contact types that are synthetically generated. For example, such synthetic sequence of contact types may be randomly generated, where the times (e.g., 8:57, 8:59, etc.), time periods (e.g., t1ᵢ, t2ᵢ, etc.), contact types (C₁, C₂, C₃, C₄, C₅, etc.), and/or agent types (A₁, A₂, A₃, A₄, A₅, etc.) may be ordered but determined randomly, for various random contact and/or agent types, resulting in various permutations of initial sequences (e.g., initial sequence 510). Additionally, or alternatively, the synthetic sequence of contact types may be generated for specific times, time periods, contact types, and/or agent types, where the initial sequence 510 may be manipulated or generated in order to test one or more specific sequences.

In some implementations, as shown in FIG. 5, initial sequence 510 comprises a sequence of contact center event data as occurring between t1ᵢ and t9ᵢ.

With reference to initial sequence 510, algorithm execution 500, e.g., as implemented by one or more processors of a contact center system (e.g., contact center system 100 and/or contact center system 200), determines one or more agent start times. For example, as shown start times (8:57 and 8:59, respectively) are determined for each of agent A₁ and agent A₂, who are agents of the contact center.

Further with reference to initial sequence 510, algorithm execution 500, e.g., as implemented by one or more processors of the contact center system, determines one or more agent end times, for example, 9:20 and 9:22 for each of agent A₁ and agent A₂, respectively.

Algorithm execution 500 for initial sequence 510, e.g., as implemented by one or more processors of the contact center system, further includes obtaining a sequence of contact types for contacts paired to the one or more agents between the one or more agent start times and the one or more agent end times. The sequence of contact types may be ordered in time. For example, as shown for initial sequence 510, initial sequence 510 includes a sequence of contact types that comprises contact C₁ having a contact type 1 and contact C₂ having a contact type 2. Contact C₂ is paired with agent A₁ and contact C₁ is paired with agent A₂. Algorithm execution 500 may further determine other contact center event data between at least one agent start time and agent end time; the sequence of contact center event data is ordered in time across t1ᵢ to t9ᵢ.

A simulation model (e.g., such as simulation model 150 as described herein) may be used to generate a simulated sequence of contact center data, such as illustrated for simulated sequence 560. The simulated sequence 560 may be generated by the simulation model and may implement a simulated pairing algorithm. For example, implementation of algorithm execution 500 may be at least partially different for the simulated sequence of contact types where the simulated sequence implements a different simulated paring algorithm that causes algorithm execution 500 to operate differently, even though each of the simulated sequence 560 and initial sequence 510 are ordered in time (e.g., across time periods t1ᵢ to t9ᵢ for initial sequence 510 and respective time periods t1ₛ to t9ₛ for simulated sequence 560).

For example, as shown for simulated sequence 560, time periods t1ₛ to t4ₛ comprise the same contact center event data as for t1ᵢ to t4ᵢ, where the agent log in times and the contact arrival times are the same for each of simulated sequence 560 and initial sequence 510, where the above description for initial sequence 510 for t1ᵢ to t4ᵢ, applies to the time periods t1ₛ to t4ₛ for simulated sequence 560.

In the example of FIG. 5, initial sequence 510 differs from simulated sequence 560 at time period t5ᵢ to time period t9ᵢ and time period t5ₛ to time period t9ₛ, respectfully. In some aspects, a simulation model (e.g., simulation model 150) may begin execution while the contact center system (e.g., contact center system 100 and/or contact center system 200) is operating. Additionally, or alternatively, a simulation model (e.g., simulation model 150) may execute separate from and/or not during operation of the contact center system (e.g., contact center system 100 and/or contact center system 200) is operating.

In examples where the simulation model executes during operation of the contact center system, initial sequence 510 represents the contact center implementing a first pairing algorithm (FIFO) for algorithm execution 500, but simulation model simulates simulated sequence 560. In some aspects, the contact center may be updated or configured to implement simulated sequence 560 implementing a BP pairing strategy for algorithm execution 500.

In the example of FIG. 5, sequence portion 515 is a sequence interval of initial sequence 510 that would be executed by algorithm execution 500 using a FIFO pairing strategy. Sequence portion 565 is a sequence interval of initial sequence 560 that would be executed by algorithm execution 500 using, for example, a BP pairing strategy. As shown, at time period t4ᵢ, simulation (550) begins in the contact center where the simulated pairing algorithm (BP pairing) of simulated sequence 560 causes different execution by algorithm execution 500 compared with initial sequence 510. The difference begins at simulated time period t5ₛ. Sequence portion 565 represents a sequence interval of simulated sequence 560 that algorithm execution 500 implements during simulation (550) for a simulated pairing algorithm (e.g., BP pairing).

In sequence portion 515 a FIFO pairing strategy is demonstrated, where algorithm execution 500 pairs A₁ to C₂ because A₁ logs in first and/or C₂ arrives first at the contact center in initial sequence 510. Further, according to the example of sequence portion 515, algorithm execution 500, implementing a FIFO pairing strategy, pairs A₂ to C₁ second because A₂ logs in second and/or C₂ arrives second at the contact center in initial sequence 510. With regard to performance metrics, the FIFO pairing strategy results in a 10 minute handle time (HT) when A₁ is paired to C₂, where A₁ is free at 9:15 and logs out at 9:20. The FIFO pairing strategy results in a 15 minute handle time (HT) when A₂ is paired to C₁ where A₂ is free at 9:21 and logs out at 9:22. It is to be understood, however, that other performance metrics, either together or alone, may be measured or determined, such as a telecommunication connection utilization of the contact center (e.g., number of connections), a resource utilization of the contact center (e.g., processor and/or memory usage of computing devices within a contact center system), a contact resolution metric associated with one or more contacts (e.g., handle time, customer satisfaction, or efficiency), and/or a transaction metric (e.g., a transaction completion indication and/or a sales or revenue data) associated with one or more contacts and/or agents in a given sequence (e.g., initial sequence 510 and/or simulated sequence 560).

In the example of FIG. 5, when the contact center system (e.g., contact center system 100 and/or contact center system 200) begins simulation (550) with the simulated sequence, algorithm execution 500 will operate according to a second pairing strategy, different than the pairing strategy used during the initial sequence 510. The simulated sequence may occur in parallel with, or after the occurrence of, initial sequence 510 for measurement, testing, or determination of simulated sequence 560 and/or initial sequence 510 (e.g., via measurement, testing, or determination of related performance metrics). Pairing in simulated sequence 560 comprises pairing, by a simulation model (e.g., simulation model 150), a simulated sequence of contact types to one or more simulated agents. The one or more simulated agents may correspond to one or more actual agents of the contact center. Each of the one or more simulated agents may have a simulated agent start time and a simulated agent end time. The simulated agent start time may be based on an actual agent start time from the initial sequence 510, and the simulated agent end time may be based on an actual agent end time from the initial sequence 510. For example, as shown for FIG. 5, time periods t1ₛ and t2ₛ of simulated sequence 560 may represent simulated agents A₁ and A₂, respectively, that correspond to actual agents A₁ and A₂ of initial sequence 510 at time periods t1ᵢ and t2ᵢ.

In one exemplary implementation, sequence portion 565 can demonstrate a diagonal model BP pairing strategy, where algorithm execution 500 pairs A₂ to C₂ because A₂ and C₂ are in similar percentiles or otherwise correlated according to the diagonal model BP strategy being implemented by algorithmic execution 500. Further, according to the example of sequence portion 515, algorithm exaction 500 pairs At to C₁ because A₁ and C₁ are in similar percentiles or otherwise correlated according to the BP strategy being implemented by algorithmic execution 500. With regard to performance metrics, the BP pairing strategy of sequence portion 565 results in a 6 minute handle time (HT) when A₂ is paired to C₂, where A₂ is free at 9:11 and logs out at 9:16. This results in an improvement compared with the FIFO strategy of sequence portion 515 because the contact center resources (e.g., such as connection resources and/or processing resources of computing devices within the contact center) corresponding to agent A₂ are freed four minutes earlier than in initial sequence 510. Still further, the BP pairing strategy results in a 4 minute handle time (HT) when A₁ is paired to C₁ where A₁ is free at 9:10 and logs out at 9:15, thereby further freeing contact center resources (e.g., such as connection resources and/or processing resources of computing devices within the contact center). Again, this results in an improvement compared with the FIFO strategy of sequence portion 515. It is to be understood, however, that other performance metrics may, alone or together, be measured or determined, such as a telecommunication connection utilization of the contact center (e.g., number of connections), a resource utilization of the contact center (e.g., processor and/or memory usage of computing devices within a contact center system), a contact resolution metric associated with one or more contacts (e.g., handle time, customer satisfaction, or efficiency), and/or a transaction metric (e.g., a transaction completion indication and/or a sales or revenue data) associated with one or more contacts and/or agents in a given sequence (e.g., initial sequence 510 and/or simulated sequence 560). Additionally, or alternatively, performance of the contact center, and related metrics, may also be measured, determined, or tested in terms of the resources, such as computer memory, processing, connections, whether networking or telephonic connections, of the contact center, as used by any of agents A₁ and/or A₂, contacts C₁ and/or C₂. For example, pairing an agent (e.g., A₁ or A₂) of the contact center to a contact comprises establishing a telecommunication connection to provide voice communication between the agent and the contact (e.g., either C₁ or C₂). Such pairing requires not only telephonic connections, but may also require processor, memory, and networking connection and/or bandwidth of the contact center. Therefore, in this way, the simulation of sequence portion 565 may be used to measure and determine performance metrics of such resources, in order to, for example, compare and reduce resource requirements, e.g., as compared to other sequences (e.g., sequence portion 515) for more efficient pairing algorithms or otherwise contact sequences, e.g., as determined for certain times, dates, or otherwise for the contact center.

For example, although not shown in FIG. 5, the simulated sequence may modify any one or more of the contact center events shown in the initial sequence 519. For example, a time that any contact arrived may be modified, where for example, the time that C₂ arrived may be modified to come after C₁, e.g., at 9:04:30. Such a modification of sequence (e.g., initial sequence 510) can make algorithm execution 500 behave differently, which in turn causes contact center system to behave differently, based on the pairing strategy being implemented at the contact center system. Additionally, or alternatively, a type of the contact (e.g., a percent value, as described for FIG. 4 for a given performance metric, or a percentile for which the contact is within for a given performance metric) and/or an agent type may be modified. For example, C₁ may be modified to have a contact type of C₃, which represents a contact type of third order or classification based on the pairing strategy (e.g., BP, FIFO, PBR, etc.) being implemented by the contact center system. Likewise, A₁ may be modified to have an agent type of A₄, which represents an agent type of fourth order or classification based on the pairing strategy (e.g., BP, FIFO, PBR, etc.) being implemented by the contact center system. Modification of either the contact type and/or agent type in a given sequence can make algorithm execution 500 behave differently, and therefore the contact center system behave differently, based on the pairing strategy being implemented at the contact center system.

As described above, the contact center may be updated to operate based on the simulated pairing algorithm in order to achieve the improved performance metric(s) as determined by the simulated pairing sequence or algorithm. For example, in some aspects, a switch (e.g., any one of central switch 110, switch 120A, switch 120B, and/or switch 280, and/or otherwise equipment of the contact center system such as a PBX and/or ACD as described herein) of the contact center system may be configured to route at least a portion of one or more contacts based on the simulated pairing algorithm. By updating, or otherwise configuring, the contact center to use the simulated pairing algorithm, the contact center (and at least a portion of its underlying computing technology, e.g., connections and usage thereof) can be improved by a new, efficient algorithm as determined by the simulation.

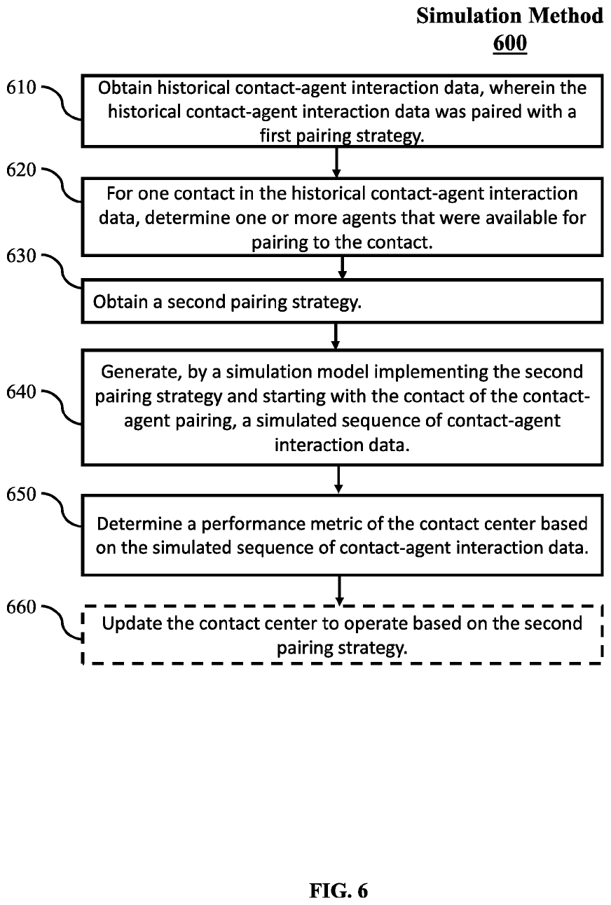

FIG. 6 illustrates a computer-implemented method 600 for simulating telecommunication contact events, agent events, and contact-agent pairing events, and analyzing contact center performance based the simulated telecommunication contact events, agent events, and contact-agent pairing events, in accordance with various aspects of the present disclosure. Computer-implemented method 600 comprises an algorithm or computing instructions as may be implemented in a contact center, or contact center system (e.g., contact center system 100, contact center system 200A, and/or contact center system 200B), and may involve the processing of input data and the generation of output data, both of which may comprise call center related data, including data regarding agents, contacts, (or events thereof, including arrival of contacts and/or availability of agents) and/or determination of performance metrics as described herein. Input data and output data receipt, transmission, and/or generation may be implemented in hardware or software components of contact center system. For example, specific electronic components may be employed in a pairing algorithm, as implemented on one or more processors and/or memories of a contact center system, or similar or related circuitry for implementing the functions associated with simulations and/or pairing in a contact center system (e.g., contact center system 100, contact center system 200A, and/or contact center system 200B). Additionally, one or more processors operating in accordance with computing instructions may implement the functions associated with pairing and/or simulation in a contact center system (e.g., contact center system 100, contact center system 200A, and/or contact center system 200B) as described herein, including for method 600. Such instructions may be stored on one or more non-transitory processor readable storage media (e.g., a magnetic disk or other storage medium), or transmitted to one or more processors via one or more signals embodied in one or more carrier waves, for example, across one or more computer buses and/or computer networks. In various aspects, the one or more processors that implement the algorithm of method 600, or otherwise execute the computing instructions as described herein, may comprise one or more processors of a computing device of the contact center system itself, such as one or more processors of a computing device, server, router, or the like that is communicatively coupled to the contact center system.

Further, the present disclosure notes that contact centers may desire to look at individual contact-agent pairings, and compare a pairing that a contact actually received under a first pairing strategy, with a pairing that the contact would have received under a second pairing strategy. For example, a contact center may wish to perform this analysis for a group of contacts over a period of time. One method of doing so, for a group of contacts (C₁, C₂, C₃, C₄, C₅, and C₆), and that were originally paired to agents in the following pairs under a first pairing strategy, would be:
Determine which agent(s) are available for pairing when C1 is available to be paired according to historical data; pair C1 according to the second pairing strategy;
Determine which agent(s) are available for pairing when C2 is available to be paired according to the historical data; pair C2 according to the second pairing strategy;
Determine which agent(s) are available for pairing when C3 is available to be paired according to the historical data; pair C3 according to the second pairing strategy;
Determine which agent(s) are available for pairing when C4 is available to be paired according to the historical data; pair C4 according to the second pairing strategy;
Determine which agent(s) are available for pairing when C5 is available to be paired according to the historical data; pair C5 according to the second pairing strategy; and
Determine which agent(s) are available for pairing when C6 is available to be paired according to the historical data; pair C6 according to the second pairing strategy.

However, such a method may be inaccurate because once C1 is paired to a different agent, such a method does not account for changes to this historical data which would affect which agents are available for pairing to C2. For example, such a method may wrongly include the agent that C1 was paired to under the second pairing strategy when determining the agents available for pairing to C2 or may wrongly exclude the agent that C1 was originally paired to under the first pairing strategy when determining the agents available for pairing to C2.

Method 600 of FIG. 6 newly presents a method 600, which may more accurately evaluate a second pairing strategy. With reference to FIG. 6, at block 610, computer-implemented method 600 comprises obtaining historical contact-agent interaction data, wherein the historical contact-agent interaction data was paired with a first pairing strategy.

At block 620, method 600 further comprises, for one contact in the historical contact-agent interaction data, determine one or more agents that were available for pairing to the contact. For example, in FIG. 5, both A1 and A2 were available for pairing to C2 at 9:05.

At block 630, method 600 further comprises, obtaining a second pairing strategy.

At block 640, method 600 further comprises, generating, by a simulation model implementing the second pairing strategy and starting with the contact of the contact-agent pairing, a simulated sequence of contact-agent interaction data. Therefore, block 640 may include:
Determine which agent(s) are available for pairing when C1 is available to be paired according to historical data; pair C₁ according to the second pairing strategy;
Determine which agent(s) are available for pairing when C2 is available to be paired based on historical data, said second pairing of C1, and a first pairing of C1 in the historical data; pair C2 according to the second pairing strategy;
Determine which agent(s) are available for pairing when C3 is available to be paired based on historical data, said second pairings of C1/C2, and first pairings of C1/C2 in the historical data; pair C3 according to the second pairing strategy;
Determine which agent(s) are available for pairing when C4 is available to be paired based on historical data, said second pairings of C1/C2/C3, and first pairings of C1/C2/C3 in the historical data; pair C4 according to the second pairing strategy;
Determine which agent(s) are available for pairing when C5 is available to be paired based on historical data, said second pairings of C1/C2/C3/C4, and first pairings of C1/C2/C3/C4 in the historical data; pair C5 according to the second pairing strategy; and
Determine which agent(s) are available for pairing when C6 is available to be paired based on historical data, said second pairings of C1/C2/C3/C4/C5, and first pairings of C1/C2/C3/C4/C5 in the historical data; pair C6 according to the second pairing strategy.

At block 650, method 600 further comprises, determining a performance metric of the contact center based on the simulated sequence of contact-agent interaction data. That is, the performance metric can be decided for said second pairings of C1, C2, C3, C4, C5, and C6 according to the second pairing strategy.

At block 660, method 600 optionally further comprises, updating the contact center to operate based on the second pairing strategy.

That is, it would be insufficient and incorrect to look at individual contact-agent pairings in a historical data set, and determine performance metrics for each contact based on which agents were available at the pairing of said contact. Rather, the present disclosure newly provides a sophisticated method to implement a second pairing strategy on a historical data set which used a first pairing strategy, and provide updated agent state availability for second contact-agent pairings.

### Additional Considerations

The present techniques may involve the processing of input data and the generation of output data to some extent. This input data processing and output data generation may be implemented in hardware or software. For example, specific electronic components may be employed in a behavioral pairing module or similar or related circuitry for implementing the functions associated with contact assignment in accordance with the present disclosure as described above. Alternatively, one or more processors operating in accordance with instructions may implement the functions associated with contact assignment in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves.

The description herein describes network elements, computers, and/or components that may include one or more modules. As used herein, the term “module” may be understood to refer to computing software, firmware, hardware, and/or various combinations thereof. Modules, however, are not to be interpreted as software which is not implemented on hardware, firmware, or recorded on a non-transitory processor readable recordable storage medium (i.e., modules are not software per se). It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

The present disclosure is not to be limited in scope by the specific aspects described herein. Indeed, other various aspects of and modifications to the present disclosure, in addition to those described herein, will be apparent to those of ordinary skill in the art from the foregoing description and accompanying drawings. Thus, such other aspects and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes.

What is claimed is:

1. A computer-implemented method for simulating telecommunication contact types and analyzing contact center performance based the simulated telecommunication contact types, the computer-implemented method comprising:
determining an agent start time for an agent of a contact center;
determining an agent end time for the agent;
obtaining a sequence of contact types paired to the agent between the agent start time and the agent end time, wherein the sequence of contact types is ordered in time;
generating, by a simulation model implementing a simulated pairing algorithm, a simulated sequence of contact types, wherein the simulated sequence of contact types is ordered in time, and wherein the simulated sequence of contact types is different from the sequence of contact types;
pairing, by the simulation model, the simulated sequence of contact types to a simulated agent, the simulated agent corresponding to the agent of the contact center, and the simulated agent having a simulated agent start time and a simulated agent end time,
wherein the simulated agent start time is based on the agent start time, and
wherein the simulated agent end time is based on the agent end time, and
determining a performance metric of the contact center based on the simulated sequence of contact types.

2. The computer-implemented method of claim 1 further comprising updating the contact center to operate based on the simulated pairing algorithm.

3. The computer-implemented method of claim 2, wherein a switch of the contact center is configured to route at least a portion of one or more contacts based on the simulated pairing algorithm.

4. The computer-implemented method of claim 1, wherein the sequence of contact types comprises a historic sequence of contact types as received at the contact center.

5. The computer-implemented method of claim 1, wherein the sequence of contact types comprises a synthetic sequence of contact types.

6. The computer-implemented method of claim 1, wherein the sequence of contact types comprises a modified historic sequence of contact types as received at the contact center, the modified historic sequence of contact types comprising at least one augmented contact type as modified from a historic contact type as received at the contact center.

7. The computer-implemented method of claim 1, wherein the performance metric comprises at least one of: a telecommunication connection utilization of the contact center, a resource utilization of the contact center, a contact resolution metric associated with one or more contacts, or a transaction metric associated with one or more contacts.

8. A system configured to simulate telecommunication contact types and to analyze contact center performance based the simulated telecommunication contact types, the system comprising:
one or more processors communicatively coupled to a contact center;
computing instructions, configured for execution by the one or more processors, and that when executed by the one or more processors, cause the one or more processors to:
determine an agent start time for an agent of the contact center;
determine an agent end time for the agent;
obtain a sequence of contact types paired to the agent between the agent start time and the agent end time, wherein the sequence of contact types is ordered in time;
generate, by a simulation model implementing a simulated pairing algorithm, a simulated sequence of contact types, wherein the simulated sequence of contact types is ordered in time, and wherein the simulated sequence of contact types is different from the sequence of contact types;
pair, by the simulation model, the simulated sequence of contact types to a simulated agent, the simulated agent corresponding to the agent of the contact center, and the simulated agent having a simulated agent start time and a simulated agent end time,
wherein the simulated agent start time is based on the agent start time, and
wherein the simulated agent end time is based on the agent end time, and
determine a performance metric of the contact center based on the simulated sequence of contact types.

9. The system of claim 8, wherein the computing instructions are further configured to cause the one or more processors to update the contact center to operate based on the simulated pairing algorithm.

10. The system of claim 9, wherein a switch of the contact center is configured to route at least a portion of one or more contacts based on the simulated pairing algorithm.

11. The system of claim 8, wherein the sequence of contact types comprises a historic sequence of contact types as received at the contact center.

12. The system of claim 8, wherein the sequence of contact types comprises a synthetic sequence of contact types.

13. The system of claim 8, wherein the sequence of contact types comprises a modified historic sequence of contact types as received at the contact center, the modified historic sequence of contact types comprising at least one augmented contact type as modified from a historic contact type as received at the contact center.

14. The system of claim 8, wherein the performance metric comprises at least one of: a telecommunication connection utilization of the contact center, a resource utilization of the contact center, a contact resolution metric associated with one or more contacts, or a transaction metric associated with one or more contacts.

15. A tangible, non-transitory computer-readable medium storing computing instructions for simulating telecommunication contact types and analyzing contact center performance based the simulated telecommunication contact types, that when executed by one or more processors cause the one or more processors to:
determine an agent start time for an agent of a contact center;
determine an agent end time for the agent;
obtain a sequence of contact types paired to the agent between the agent start time and the agent end time, wherein the sequence of contact types is ordered in time;
generate, by a simulation model implementing a simulated pairing algorithm, a simulated sequence of contact types, wherein the simulated sequence of contact types is ordered in time, and wherein the simulated sequence of contact types is different from the sequence of contact types;
pair, by the simulation model, the simulated sequence of contact types to a simulated agent, the simulated agent corresponding to the agent of the contact center, and the simulated agent having a simulated agent start time and a simulated agent end time,
wherein the simulated agent start time is based on the agent start time, and
wherein the simulated agent end time is based on the agent end time, and
determine a performance metric of the contact center based on the simulated sequence of contact types.

16. The tangible, non-transitory computer-readable medium of claim 15, wherein the computing instructions are further configured to cause the one or more processors to update the contact center to operate based on the simulated pairing algorithm.

17. The tangible, non-transitory computer-readable medium of claim 16, wherein a switch of the contact center is configured to route at least a portion of one or more contacts based on the simulated pairing algorithm.

18. The tangible, non-transitory computer-readable medium of claim 15, wherein the sequence of contact types comprises a historic sequence of contact types as received at the contact center.

19. The tangible, non-transitory computer-readable medium of claim 15, wherein the sequence of contact types comprises a synthetic sequence of contact types.

20. The tangible, non-transitory computer-readable medium of claim 15, wherein the sequence of contact types comprises a modified historic sequence of contact types as received at the contact center, the modified historic sequence of contact types comprising at least one augmented contact type as modified from a historic contact type as received at the contact center.
